(19) United States
(12) Patent Application Publication
(10) Pub. No.: US 2004/0015834 A1
(43) Pub. Date: Jan. 22, 2004

(54) Method and apparatus for generating serialization code for representing a model in different type systems

(76) Inventors: Lionel Mestre, Lavilledieu (FR); Alexander K. MacAulay, Vancouver (CA); Kyle N. Patrick, Pitt Meadows (CA); Arvind Viswanathan, Vancouver (CA)

Correspondence Address: INTERNATIONAL BUSINESS MACHINES CORPORATION, INTELLECTUAL PROPERTY LAW, DEPT. QPZA/ 210, 8501 IBM DRIVE, CHARLOTTE, NC, 28262, US

(21) Appl. No.: 10/015,310

(22) Filed: Dec. 12, 2001

(30) Foreign Application Priority Data
Dec. 20, 2000 (CA) 2,329,559

(51) Int. Cl. G06F 9/44

(52) U.S. Cl. 717/106; 717/114

(57) ABSTRACT

In order to use object-oriented models over the Internet for applications in different type systems it is necessary to marshal and unmarshal objects between Java, SQL and XML. Hand-writing specific code to do this is difficult. A computer-implemented method of generating serialization code for representing a model in a plurality of type systems is disclosed, the method comprising the steps of: i) producing an input file from the model for a given set of objects; and ii) providing a code generator for acting on the input file to generate the serialization code.

### BACKGROUND OF THE INVENTION

1. Field of the Invention

The invention relates to the field of computer software for generating code, and more particularly to software for generating code for marshalling objects in a distributed computer network.

2. Description of Related Art

Multi-tier architectures in computer software applications have become widespread due to the importance of the Internet environment, and particularly the World Wide Web, which commonly involves communication between a first subset of computers which are the source of information and documents, referred to herein as “servers”, and a second subset of computers which request such information and documents from servers, referred to herein as “clients”. The servers often must communicate with a database management system to obtain data. Thus there is typically a client tier, an application tier including the application server and a database tier including a database server. HTTP, SOAP, XML and Java are the commonly-used protocols and languages to provide reliable means of communication over the Internet. Different tiers often use different type systems. For example the database server will often use SQL while the application server might use Java and XML and a client may use Visual Basic or Java.

Object oriented programming is widely used to facilitate the software development process. For example, various visual modelling software based on UML is available to assist software developers. Such tools allow programmers to build and describe a set of objects and relationships to model the business process of interest.

Glossary

The following terms have the following meanings well understood in the art:

Binding information

Information allowing the translation of names or structures used in one type system into the relevant names and structures used in another type system.

Class

1A generalization used in programming languages to indicate a set of objects with common attributes (e.g. a Car class could be defined to generalize GM and Ford cars). Specific instances of a Class used in a program are called Objects.

Formal description

A carefully specified (in a mathematical or computational sense) description that is usually independent of any implementation or platform.

Generated code

Source code generated by a tool.

Generic code

Code able to handle a large variety of inputs by using some meta-data on those inputs.

Graph

A graph—in the sense used in graph theory—consists of nodes (also called points, or vertices) and of edges (lines) connecting certain pairs of nodes. The exact geometric pattern is not specified. In a directed graph (digraph) all edges are given a direction.

HTTP

Hypertext Transfer Protocol (HTTP) is the set of rules for exchanging files (text, graphic images, sound, video, and other multimedia files) on the World Wide Web.

Inheritance

In object oriented programming, inheritance is a way for a class to extend the behaviour of another class while adding or changing the original behaviour. The original class is called the base, super, parent or extended class. The class extending the other is called the derived or inherited or sub or child class.

Java™

Java is a programming language expressly designed for use in the distributed environment of the Internet. Java is a trademark of Sun Microsystems Inc.

Marshalling—Unmarshalling

The process of gathering (marshalling) data from a number of sources, placing the data into a buffer and organizing the data into a desired format. Unmarshalling is the opposite process. This is often also referred to as serialization/unserialization.

Optimize

Making the code better by reducing the time and resources needed to run the code.

Primitive types

In Object Oriented Programming these are types that are not Objects, such as int, float, double etc.

Rational Rose™

Visual (object oriented) modelling tool from Rational Software Corporation (“Rational Object Oriented Software Engineering”) for software developers and architects. It uses UML as a modelling language to identify and organize the requirements and structure of an application and model business processes.

Reflection

Getting meta-information about an object at runtime.

Relationship

Relation between objects in a model.

SOAP

SOAP (Simple Object Access Protocol) is a way for a program running in one kind of operating system to communicate with a program in the same or another kind of an operating system by using the World Wide Web's Hypertext Transfer Protocol and its Extensible Markup Language (XML) as the mechanisms for information exchange.

SQL

SQL (Structured Query Language) is a standard interactive and programming language for getting information from and updating a database.

Type systems

These include Java, C++, Visual Basic, XML, XMI, XSL, SQL and others.

UML

Unified Modelling Language (“UML”) is a standard notation for the modelling of real-world objects. It is an evolution of early approaches to object-oriented analysis and design.

XMI

XML Metadata Interchange (“XMI”) is a proposed standard syntax to allow the exchange of UML model meta-data using XML.

XML

Extensible Markup Language (“XML”) is a standard language or syntax for describing hierarchical data (names and structure) designed for network communications in which markup symbols or tags enable the definition, representation, transmission, validation, and interpretation of data between sending and receiving computers. An XML document (or collection of data) can conform to a XML vocabulary definition (and be validated against it).

XML Vocabulary

A specific set of tags that constrain an XML document's data to have a particular set of names and structure. These are often defined in the context of a vertical industry (e.g. banking).

XSL

Extensible Stylesheet Language, formerly called Extensible Style Language, is a language for transforming XML documents, often used to transform them into web pages (HTML).

Sending the data held in objects in a type system (e.g. Java) through HTTP using XML (as is done using SOAP) requires that the objects be first marshalled to XML and then on the other end, to be unmarshalled from XML into new objects (in Java or another programming language). Information needed to build those Java objects is usually stored in a database or comes from a legacy system. It is a common programming problem to need to convert between several type systems such as Java, XML or SQL and using various XML vocabularies. Although it might be possible to have generic code doing those tasks (if using Java with the reflection API (Application Program Interface) for instance), such code could not perform as well as specific code written for each object and usually does not perform well enough. Hand writing specific code such as the one to do the marshalling and unmarshalling between Java and XML is a daunting task, error prone and difficult to maintain.

Previous attempts at marshalling and unmarshalling Java objects to/from XML as well as persisting and retrieving Java objects to/from a database have been made. Examples are the following:

Quick 1.2: http://www.jxml.com/index.html

Exolab Castor 0.8.8: http://castor.exolab.org/

Adelard: http://java.sun.com/xml/docs/binding/DataBinding.html

These methods all focus on the conversion from one type system to another and do not have the concept of using an object model. There is therefore a need for a system which solves the conversion between any number of type systems, provides a means to reuse an object model definition from a standard UML description (in XMI), provides a complete description of the model and the binding information in one simple XML format, and supports inheritance at runtime. Note also that driving the system from a central type system independent model increases reuse and improves the scaling of the number of inter type system bindings that need to be specified (from order N² to order N where N is the number of type systems).

### BRIEF SUMMARY OF THE INVENTION

The present invention solves the conversion between any number of type systems. In addition the invention provides the definition of a complete description of the model (exported from a UML description) and the binding information in one simple XML format. The invention also supports inheritance at runtime and the use of graphs to create XML messages and optimizes database queries.

The invention therefore provides a computer-implemented method of generating serialization code for representing a model in a plurality of type systems, the method comprising the steps of: i) producing an input file from the model for a given set of objects; ii) providing a code generator for acting on the input file to generate the serialization code.

The invention further provides a data processing system for generating serialization code for representing a model in a plurality of type systems, the data processing system comprising: i) means for producing an input file from the model for a given set of objects; and ii) means for providing a code generator for acting on the input file to generate the serialization code.

The invention further provides a computer program product for generating serialization code for representing a model in a plurality of type systems, the computer program product comprising: a computer usable medium having computer readable program code means embodied in the medium for producing an input file from the model for a given set of objects; and the computer usable medium having computer readable program code means embodied in the medium for providing a code generator for acting on the input file to generate the serialization code.

The invention further provides an article comprising: a computer readable modulated carrier signal; means embedded in the signal for producing an input file from the model for a given set of objects; and means embedded in the signal for providing a code generator for acting on the input file to generate serialization code.

These and other advantages of the invention are set forth in conjunction with the following detailed description. Still further advantages will become apparent to those skilled in the art from a reading of the description as well as from practicing the invention. The advantages of the invention are realized from the elements and their combinations which are particularly pointed out in the claims and their equivalents.

### BRIEF DESCRIPTION OF THE DRAWINGS

FIG. 1 is a schematic diagram illustrating the invention;

FIG. 2 is a flowchart illustrating code generation according to the invention;

FIG. 3 is a flowchart illustrating in further detail code generation according to the invention;

FIG. 4 is a schematic drawing of the files generated by the invention; and

FIG. 5 is a computer architecture of the preferred embodiment of the invention.

### DETAILED DESCRIPTION OF THE INVENTION WITH PREFERRED EMBODIMENTS

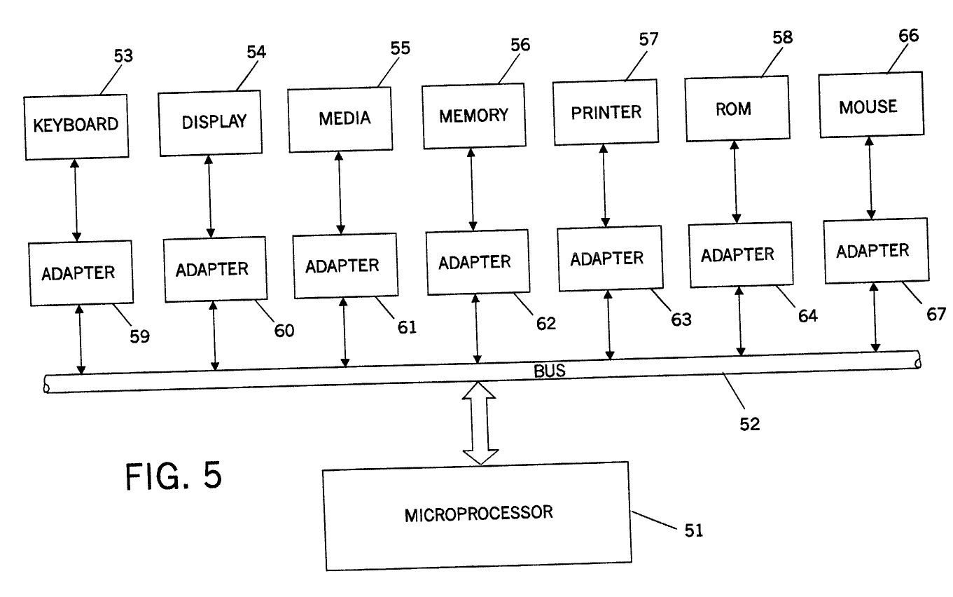

Referring first to FIG. 5, for the purpose of describing the present invention in the context of a particular embodiment, a typical computer architecture is shown, such as the configuration used in an IBM Personal Computer. The present invention may also be used in other digital computer architectures, such as mini-computer and mainframe computer environments, and in local area and wide area computer networks.

The focal point of the preferred personal computer architecture comprises a processor 51 which may, for example, be an INTEL or similar processor. The processor 51 is connected to a bus 52 which comprises a set of data lines, a set of address lines and a set of control lines. A plurality of I/O devices or memory or storage devices 53-58 and 66 are connected to the bus 52 through separate adapters 59-64 and 67, respectively. For example, the display 54 may be the IBM Personal Computer Color Display and the adapter 60 may, accordingly, be the IBM Color/Graphics Adapter. The other devices 53 and 55-58 and adapters 59 and 61-64 are either included as part of the personal computer or are available as plug-in options from the IBM Corporation.

The random access memory (RAM) 56 and the read-only memory (ROM) 58 and their corresponding adapters 62 and 64 are included as standard equipment in a personal computer, although additional random access memory to supplement memory 56 may be added via a plug-in memory expansion option.

Within the ROM 58 are stored a plurality of instructions, known as the basic input/output operating system, or BIOS, for execution by the microprocessor 51. The BIOS controls the fundamental operations of the computer. An operating system such as a windows oriented operating system software available from IBM Corporation, MICROSOFT Corporation or other supplier is loaded into the memory 56 and runs in conjunction with the BIOS stored in ROM 58. It will be understood by those skilled in the art that the personal computer system could be configured so that parts or all of the BIOS are stored in the memory 56 rather than in the ROM 58 so as to allow modifications to the basic system operations by changes made to the BIOS program, which would then be readily loadable into the random access memory 56. Similarly, programs, data, and knowledge representations stored in memory 56 may be stored in ROM 58.

The programs embodying the instant invention as well as other programs such as a word processing program may also be loaded into the memory 56 to provide instructions to the microprocessor 51 to enable a comprehensive set of word processing tasks, including the creation and revision of text documents, to be performed by the personal computer system shown in FIG. 5. An application program including the programs: Rational Rose, Java, SQL and XML with their associated files used in embodying the instant invention, is loaded into the memory 56 and runs run in conjunction with the disk operating system previously loaded into the memory 56. These programs are contained in media 55 such as a diskette or compact disc or they are part of a communication signal received at a modem or other communications connection version of media 55. Media 55 is connected to bus 52 by an adapter 61 which may be in the form of a communications adapter.

In a computer such as the IBM Personal Computer for the system shown in FIG. 5, an input device such as a mouse 66 and an adapter 67 is also provided. This mouse is available in many versions including a serial version and a bus version as well as a USB port version. Mouse 16 is an input device for interacting with the personal computer. Other input devices include keyboards, tablets, touch screens, light pens, joysticks, trackballs, and similar devices.

Personal computer architecture and components are further explained in The Winn Rosch Hardware Bible, W. L. Rosch, Simon & Schuster, ISBN 0-13-160979-3 (“Rosch”), which is specifically incorporated herein by reference.

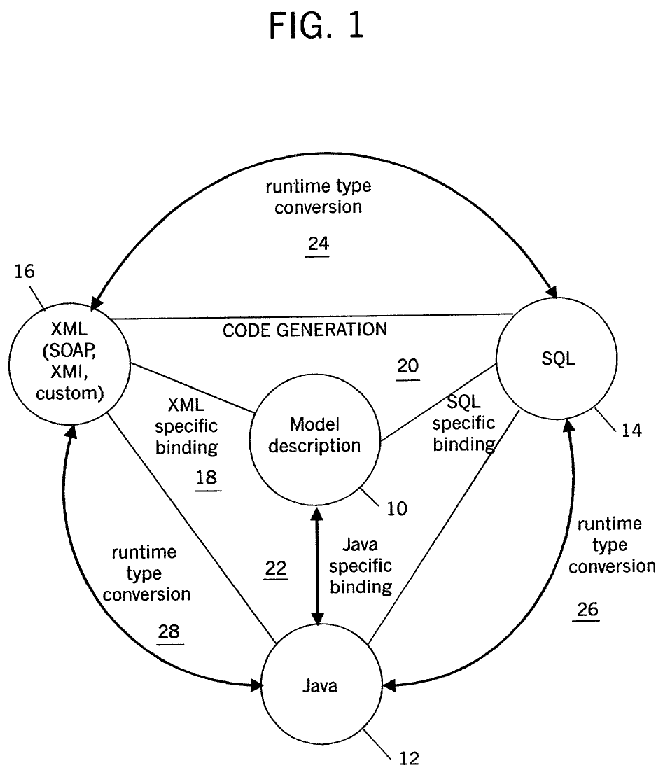

With reference now to FIG. 1, a model 10 has been created by a visual modelling tool such as Rational Rose. It comprises a number of objects defined in Unified Modelling Language. This model can be exported using XMI or XML Metadata Interchange, which is used to describe the UML model in the XML format. The present invention provides bindings between the model description 10 and a number of types such as Java 12, SQL 14 and XML 16 (which may use different vocabularies such as SOAP, XMI or custom XML). The invention generates code which at run-time allows the conversion of the object from one type to another, for example marshalling and unmarshalling code to pack or unpack Java data objects into XML messages, or convert a Java object into a relational SQL object or vice versa, or XML to SQL and back. This is done, as described as follows, in two steps: 1) the first step is to produce an input file for the given set of objects or model description 10 which is referred to as the XIDL or XML Interface Definition Language file; 2) then the generator is run to produce the Java code (or possibly C++ code) that allows the use of those objects and does all required type conversions (XML to Java, SQL to Java, XML to SQL, or possibly XML to C++, C++ to Java, etc.).

The present invention thus defines a binding between several type systems such as Java, XML (using arbitrary vocabularies) or SQL. It makes use of a type independent model description and meta-data such as the bindings (or links) to various type systems to generate all the code needed to use the objects from the model in those type systems. Thus, one object from the model can be used as a Java object, as a XML object or as a relational object stored in one table. The code that handles conversion of objects from one type to another is also generated. The code is generated from a formal description of the objects that is compact, easy to edit, read and maintain. With this approach, the description of the data model is independent from any implementation. That description is used plus meta-data 18, 20, 22 regarding the type specific binding information to generate all code needed for representation in the needed type system and any conversion between them. As shown in FIG. 1, the code generation involves the model 10 augmented by the type specific bindings XML 18, SQL 20, and Java 22. At runtime, the generated code is used to realize the type conversion 24, 26, 28 from one type to another.

Because XML is used to describe the model 10 and the meta-data 18, 20, 22, it is possible to author it directly as well as generate it partially or completely from another existing description. Typically a model is described using UML and is authored in a tool like Rational Rose. With the information obtained from the high level description of the model exported from Rational Rose (as XMI) the XML description for the model is generated.

The invention is based on the following inputs:

the description of the model;

the binding information for the objects of the model between the different type systems;

the graphs that describe the relationships between the objects;

the type conversion information that describes how to convert a non-primitive type to a string. All are combined in one XML input file that contains all the information needed by the invention in order to generate the code.

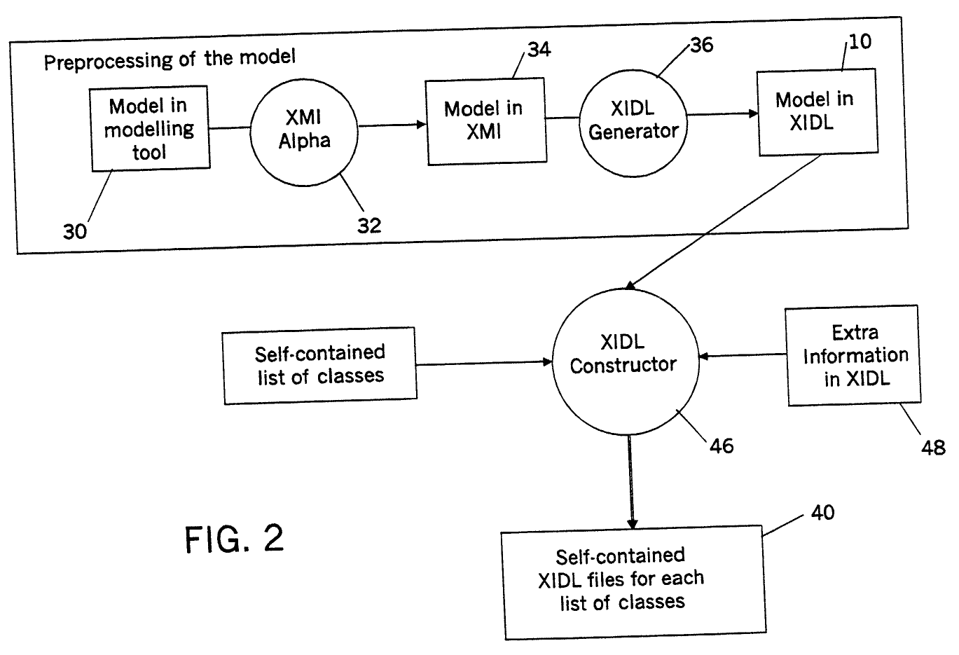

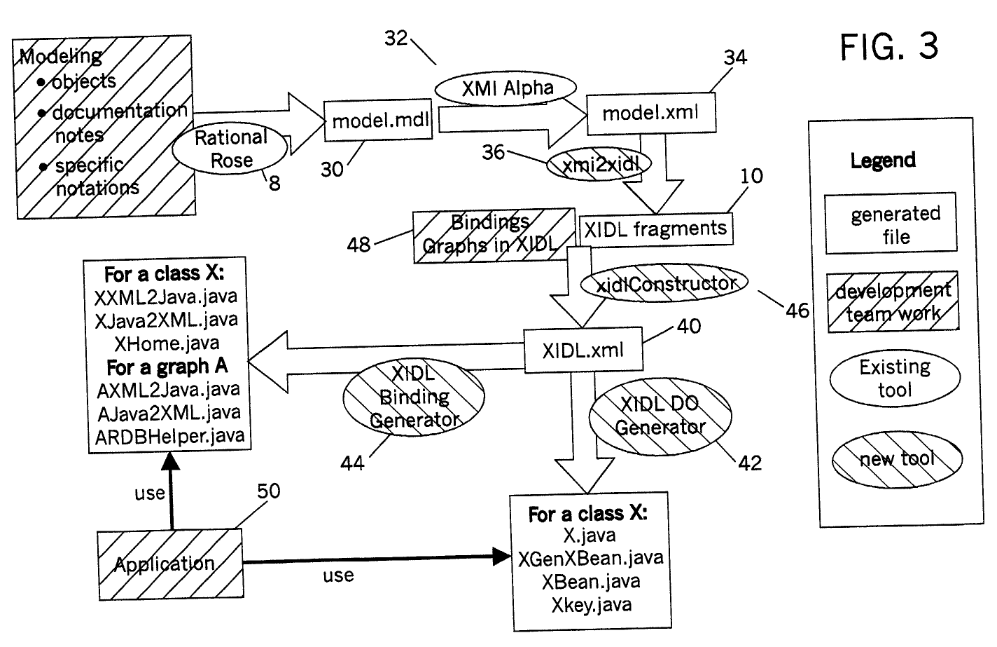

The use of the invention can be seen as a two step process, the steps being completely independent. The first step is to produce the XML input file for a given set of objects. FIGS. 2 and 3 show how the XML file 40 (called XIDL.xml file) is typically produced from a model 10 described in Rational Rose. The second step is to run the code generators to produce the Java code that allows the use of the objects of the model and do the type conversions.

1. Producing XIDL File from Model

The XIDL input file is generated as follows and as shown in FIG. 2 and FIG. 3. A model 30 is first generated in Rational Rose 8 or other visual modelling tool in mdl format. The model 30 is then exported as an XMI file 34 using the XMI Alpha tool 32 (i.e. the IBM XMI toolkit from alphaWorks) or other tools that conform to the XMI format. From the XMI file 34 an XSL transform automatically produces an XIDL input file that is the representation 10 of the model 30 (using XIDL Generator 36). This file 10 is then updated, using the XIDL Constructor 46, with specific type-related information including the name bindings 18, 20, 22 between the model and the different types, and graphs that describe how to use the associations between the objects of the model. The XIDL Constructor 46 generates the XIDL.xml file 40 which is the input to the code generators.

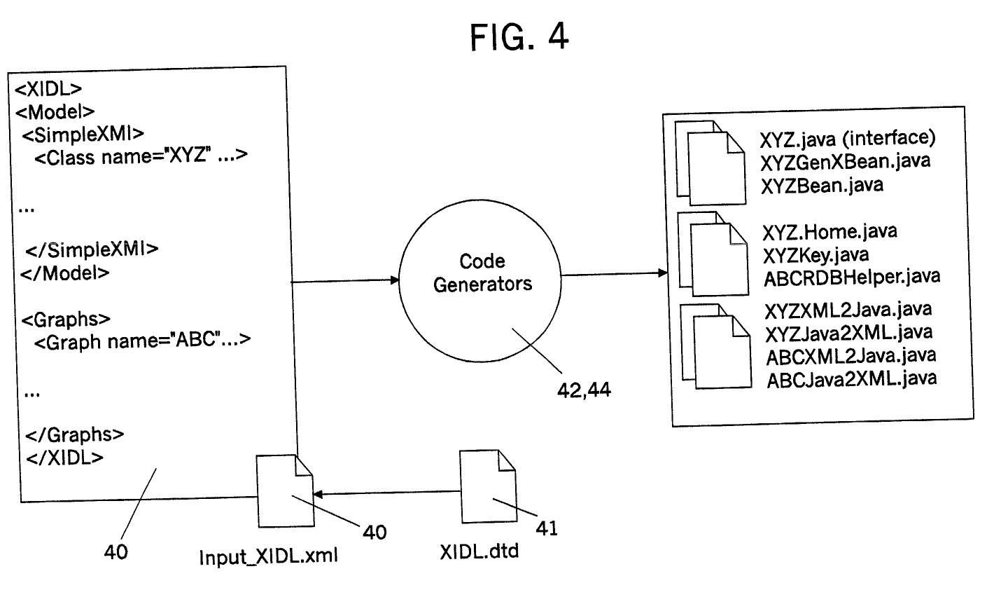

XIDL.dtd (the datatype definition of the XIDL format) 41, shown in FIG. 4, defines the XML vocabulary allowed in the XIDL input to the generator. The XIDL.xml file can be directly hand edited using a XML editor or generated from another tool (as described above). The XIDL file contains basically 3 parts:

1) Classes: These describe the model and the bindings between the model and Java, XML and SQL.

2) Graphs: As the objects from the model have associations between each other, it is necessary to know which associations are relevant at one time in a given context. A graph describes for one object the subset of associations to follow to serialize (marshal) the object. Strictly speaking, a graph is in fact a sub-graph of the fully populated graph of associations found in the model for the object in question. The sub-graphs are needed in order to serialize an object to an XML message, as it is required to know which associated objects to include in the message.

3) Type conversions: This part describes the custom helpers (functions in a programming language) that handle non-primitive types. For instance, if one object contains an attribute Date, one converter is needed to convert the Date into a string and convert the resulting string back into a Date object.

The following is a representative sample of an XIDL file:

<XIDL>

<ClassModel>

<Classes>

<Class name=“ClassInfo” package=“

com.ibm.generationx.test.doc”>

<Attribute name=“courseId” type=“int” visibility=“private”>
<InitialValue>0</InitialValue>

</Attribute>
<Association name=“associatedPerson” type=“

com.ibm.generationx.test.doc.Person”>

<AssociationKeyMap foreign=“id” local=“personId”/>

</Association>

</Class>

<Class name=“Person” package=“com.ibm.generationx.test.doc”>

<Attribute name=“id” type=“int” visibility=“private”/>
<Attribute name=“name” type=“String” visibility=“public”/>

</Class>

</Classes>
<ClassBindings>

<ClassBinding type=“com.ibm.generationx.test.doc.ClassInfo”>

?

</ClassBinding>

</ClassBindings>

</ClassModel>
<GraphModel>

<Graphs>

<Graph name=“ClassInfoGraph” type=“

com.ibm.generationx.test.doc.ClassInfo”>

<Follow name=“associatedPerson”/>

</Graph>
</Graphs>

<GraphBindings/>

</GraphModel>

</XIDL>

2. Generating the Code

The second step is to run the code generators to produce the Java code that allows the use of the objects of the model and to do the type conversions (Java <->XML, Java<->SQL, SQL<->XML) as shown in FIG. 1. The code produced by the invention provides the following functionality:

marshal objects from Java to XML;

marshal graphs of objects from Java to XML;

unmarshal objects from XML to Java;

unmarshal graphs of objects from XML to Java;

search, update, create and delete objects from a database;

search, update, create and delete graphs of objects in one transaction from the database.

From the self-contained XIDL file 40, called XIDL.xml, several code generators can be run to produce all the desired Java code. These are the XIDL DO Generator 42 and the XIDL Binding Generator 44. As shown in FIG. 4, for a class XYZ in the model 40, the code generators 42, 44 produce the following Java files:

| File name | Description |
|---|---|
| XYZ.java | The interface defining the getters and setters for |
| | all attributes and associations. |
| XYZGenXBean.java | The implementation of the above interface. |
| XYZHome.java | The Java-RDB implementation allowing the |
| | object to be retrieved and persist. |
| XYZKey.java | A helper defining the RDB key for the object. |
| XYZJava2XML.java | A helper, used internally, that marshals from Java |
| | to XML. |
| XYZXML2Java.java | A helper, used internally, that unmarshals from |
| | XML to Java. |
| XYZ.PE | An optional XML Parameter Entity defining the |
| | XYZ content model (::TODO::). |

In the graph section of the XIDL file, a graph defines which association to follow for an object when serializing it to XML. For a graph ABC in the Graphs section, the generator produces the following Java files:

| File name | Description |
|---|---|
| ABCJava2XML.java | The helper that marshals from Java to XML. |
| ABCXML2JAVA.java | The helper that marshals from XML to Java. |
| ABCRDBHelper.java | A helper that optimizes queries to the database. |
| ABC.dtd | An interface defining the compound XML |
| | document, representing ABC. |

Once the code has been generated, then an Application program 50 can use the files for the intended application.

The foregoing method therefore involves a) the definition of the XML that describes the model and the meta-data for the type binding; b) a generator that produces the XML describing the model from a description of a Model in Rational Rose (exported in XMI); and c) several code generators that produce Java code for doing type conversion between the different type systems. The method has an open architecture which allows new type systems to be added. This method has a number of advantages, including: a) it describes models in a type independent manner, simplifying support of multiple type systems and programming languages; b) integrates with common object modelling tools (e.g. Rational Rose) to allow simple authoring of these models; c) it is extensible to handle any kind of type system and type conversion; d) it handles type specific binding to provide flexibility; e) it uses graphs to describe messages based on objects of the model; f) facilitates reuse of objects in multiple messages; g) custom written code is not needed for the application software; h) there is more consistent generation of object code and faster generation of all objects; i) it allows optimization of the code in the future, for example, lazy initialization; and j) it allows retargeting the model for a different back end or application.

The present system thus solves the conversion between any number of type systems, provides the definition of a complete description of the model and the binding information in one simple XML format, and supports inheritance at runtime and the use of graphs to create XML messages and optimizes database queries.

As will be apparent to those skilled in the art in the light of the foregoing disclosure, many substitutions, alterations and modifications are possible in the practice of this invention without departing from the spirit or scope thereof. Accordingly, the scope of the invention is to be construed in accordance with the substance defined by the following claims.

What is claimed is:

1. A computer-implemented method of generating serialization code for representing a model in a plurality of type systems, the method comprising the steps of:
i) producing an input file from said model for a given set of objects;
ii) providing a code generator for acting on said input file to generate said serialization code.

2. The method of claim 1 wherein said model is exported from a UML description.

3. The method of claim 1 wherein said model comprises a plurality of objects.

4. The method of claim 1 wherein said model is exported as an XMI file.

5. The method of claim 1 wherein said plurality of type systems comprises Java and SQL.

6. The method of claim 1 wherein said input file is an XML file.

7. The method of claim 6 wherein said model is exported as an XMI file and said XML input file is produced from said XMI file by an XSL transform.

8. The method of claim 1 wherein said input file comprises binding information between said model and said plurality of type systems.

9. The method of claim 1 wherein said input file comprises graphs that describe relationships between said objects of said model.

10. The method of claim 9 wherein said graphs describe for an object a subset of associations to follow to serialize the object.

11. The method of claim 1 wherein said input file comprises the type conversion information that describes how to convert a non-primitive type to a string.

12. The method of claim 1 wherein two code generators are provided for acting on said input file to generate said serialization code.

13. The method of claim 12 wherein said two code generators are a binding generator and a DO generator.

14. A method according to claim 1, further comprising the step of:
iii) using said serialization code in an application to carry out type conversion.

15. A data processing system for generating serialization code for representing a model in a plurality of type systems, said data processing system comprising:
i) means for producing an input file from said model for a given set of objects; and
ii) means for providing a code generator for acting on said input file to generate said serialization code.

16. A data processing system according to claim 15 wherein said model is exported from a UML description.

17. A data processing system according to claim 15 wherein said model comprises a plurality of objects.

18. A data processing system according to claim 15 wherein said model is exported as an XMI file.

19. A data processing system according to claim 15 wherein said plurality of type systems comprises Java and SQL.

20. A data processing system according to claim 15 wherein said input file is an XML file.

21. A data processing system according to claim 20 wherein said model is exported as an XMI file and said XML input file is produced from said XMI file by an XSL transform.

22. A data processing system according to claim 15 wherein said input file comprises binding information between said model and said plurality of type systems.

23. A data processing system according to claim 15 wherein said input file comprises graphs that describe relationships between said objects.

24. A data processing system according to claim 23 wherein said graphs describe for an object a subset of associations to follow to serialize the object.

25. A data processing system according to claim 15 wherein said input file comprises the type conversion information that describes how to convert a non-primitive type to a string.

26. A data processing system according to claim 15 wherein two code generators are provided for acting on said input file to generate said serialization code.

27. A data processing system according to claim 26 wherein said two code generators are a binding generator and a DO generator.

28. A data processing system according to claim 15, further comprising:
iii) means for using said serialization code in an application to carry out type conversion.

29. A computer program product for generating serialization code for representing a model in a plurality of type systems, said computer program product comprising:
a computer usable medium having computer readable program code means embodied in said medium for producing an input file from said model for a given set of objects; and
said computer usable medium having computer readable program code means embodied in said medium for providing a code generator for acting on said input file to generate said serialization code.

30. A computer program product according to claim 29 wherein said model is exported from a UML description as an XMI file and wherein said model comprises a plurality of objects, and wherein said input file is an XML file, further comprising computer readable program code means embodied in said medium for producing said input file from:
i) binding information between said model and said plurality of type systems;
ii) graphs that describe relationships between said objects; and
iii) type conversion information that describes how to convert a non-primitive type to a string.

31. A computer program product according to claim 30 wherein said plurality of type systems comprises Java and SQL.

32. An article comprising:
a computer readable modulated carrier signal;
means embedded in said signal for producing an input file from said model for a given set of objects; and
means embedded in said signal for providing a code generator for acting on said input file to generate serialization code.

33. A computer-implemented method of generating a model description from a description of a model in XMI comprising a plurality of objects which is useful for generating serialization code for representing a model in a plurality of type systems, comprising producing an input file comprising:
i) binding information between said model and said plurality of type systems;
ii) graphs that describe relationships between said objects; and
iii) type conversion information that describes how to convert a non-primitive type to a string.
